(19) United States
(12) Patent Application Publication
(10) Pub. No.: US 2026/0272094 A1
(43) Pub. Date: Sep. 17, 2026

(54) ILLUMINATION DEVICE ASSEMBLY FOR HELMETS

(71) Applicants: Sammie B. Taylor, Blythewood, SC (US); James Thomas Ledbetter, JR., Lexington, SC (US); Gary B. Bell, Columbia, SC (US)

(72) Inventors: Sammie B. Taylor, Blythewood, SC (US); James Thomas Ledbetter, JR., Lexington, SC (US); Gary B. Bell, Columbia, SC (US)

(21) Appl. No.: 19/673,686

(22) Filed: May 11, 2026

Related U.S. Application Data
(63) Continuation of application No. 29/912,653, filed on Sep. 21, 2023.

(51) Int. Cl. A42B 3/04; F21S 4/00; F21S 9/02; F21V 21/08; F21V 23/00; F21W 111/10; F21Y 103/10; F21Y 115/10

(52) U.S. Cl. CPC A42B 3/044; A42B 3/0453; F21S 4/00; F21S 9/02; F21V 21/0808; F21V 23/003; F21W 2111/10; F21Y 2103/10; F21Y 2115/10

(57) ABSTRACT

An illumination device assembly can be mounted to an exterior surface of a helmet to provide enhanced visibility and coordinated signaling for a wearer. The assembly can include a base, a printed circuit board supported relative to the base, a battery, at least one LED strip extending outwardly from the base, a flexible board, a button, a top cover, at least one screw, and a double-sided tape configured to adhere the assembly to the exterior surface without penetration thereof.

### RELATED APPLICATION

This application is a continuation of U.S. patent application Ser. No. 29/912,653 filed Sep. 21, 2023, the contents of which are incorporated herein by reference in their entirety.

### BACKGROUND

The present disclosure relates generally to illumination device assemblies, and more particularly to lighting systems that can be incorporated with or mounted to helmets, such as motorcycle helmets. Such illumination device assemblies can include light-emitting components, circuitry, and power sources arranged to provide visible indications to persons or vehicles in the vicinity of the wearer.

Motorcyclists and other riders of two-wheeled or open-cab vehicles can be difficult for operators of surrounding vehicles to observe, particularly during periods of low ambient light or in heavy traffic. A substantial portion of collisions involving motorcycles can be attributed to surrounding drivers failing to perceive the presence, direction of travel, or deceleration of the motorcycle. Conventional motorcycle lighting is typically positioned at the rear and sides of the motorcycle itself, which can be at or below the eye level of drivers of larger vehicles such as trucks and sport utility vehicles, and can therefore be obscured or overlooked.

Attempts have been made to address this visibility challenge by affixing decorative light strips to helmets. In some approaches, light-emitting diode (LED) strips are adhered to helmets and connected to a battery carried by the rider, providing only a continuous illumination without any correlation to the operation of the motorcycle. In other approaches, a gyroscope-based module has been used to trigger a rear-facing brake indicator on a helmet based on sensed deceleration of the wearer, without any direct connection to the motorcycle's electrical system. Such gyroscope-based approaches can be susceptible to false activations caused by routine head movement, road irregularities, and bumps, and do not provide directional turn indication that is synchronized with the motorcycle's own turn signals.

In addition, prior helmet-mounted lighting approaches can involve structural modification of the helmet, such as drilling of holes for fasteners or integration of lighting components within the helmet shell, which can compromise the structural integrity of the helmet and reduce its protective performance. There is accordingly a need for an illumination device assembly that can provide enhanced visibility and signaling functionality for a helmet wearer while preserving the integrity of the helmet, and that can, in some embodiments, coordinate helmet-mounted indicators with the operational state of an associated vehicle.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

An embodiment of the present disclosure provides an illumination device assembly that can be associated with a helmet, such as a motorcycle helmet, to provide enhanced visibility and signaling functionality for a wearer. The illumination device assembly can include a base, a printed circuit board supported by the base, a battery, one or more LED strips, a flexible board, a button, a top cover, one or more screws, and a double-sided tape. The double-sided tape can allow the illumination device assembly to be affixed to an outer surface of a helmet without structural modification of the helmet, such that the structural integrity of the helmet can be preserved.

More specifically, an aspect of the present disclosure provides an illumination device assembly comprising: a base; a printed circuit board supported relative to the base; a battery in electrical communication with the printed circuit board; at least one LED strip in electrical communication with the printed circuit board and extending outwardly from the base; a flexible board supported relative to the base; a button operable by a user; a top cover connectable to the base; at least one screw configured to secure the top cover to the base; and a double-sided tape configured to adhere the illumination device assembly to an exterior surface.

In some embodiments, the battery can be a rechargeable battery, and in some implementations the battery can be a lithium-based battery, such as a lithium-ion or lithium-polymer battery. In some embodiments, the button can be configured as an on/off control, and the illumination device assembly can be configured such that holding the button for a predetermined period of time activates or deactivates the assembly. In some implementations, the at least one LED strip can include a plurality of LED strips extending outwardly from the base in different directions, and the LED strips can be configured to emit white light, colored light, or user-selectable colors. In some embodiments, the at least one LED strip can include a central brake indicator, and can further include side-oriented turn indicators arranged on opposite sides of the base.

In some embodiments, the illumination device assembly can be configured to wirelessly communicate with a second module configured for placement on a vehicle, such as beneath a seat of a motorcycle. The second module can include a motorcycle board bottom, a motorcycle printed circuit board, a motorcycle board top, and a hex head screw configured to secure the motorcycle board bottom to the motorcycle board top. In some implementations, the second module can include a plurality of wires configured to splice into existing wiring of the vehicle, including wiring associated with a left turn signal, a right turn signal, and a brake system, such that activation of a turn signal or brake of the vehicle can cause a corresponding indication to be displayed by the illumination device assembly on the helmet.

In some embodiments, the wireless communication between the illumination device assembly and the second module can be implemented via a Bluetooth connection, and the printed circuit board can include a wireless transceiver configured to receive signals transmitted from the second module. In some implementations, the illumination device assembly can be configured such that activation of a left turn signal of the vehicle causes a left-side portion of the at least one LED strip to flash, activation of a right turn signal of the vehicle causes a right-side portion of the at least one LED strip to flash, and activation of a brake of the vehicle causes a brake indication portion of the at least one LED strip to illuminate.

In some embodiments, the illumination device assembly and the second module can be configured to undergo a pairing procedure prior to operational use. The pairing procedure can be initiated by actuation of the button of the illumination device assembly according to a predetermined input pattern, such as a press-and-hold operation, a double-press operation, or another user input sequence. Upon successful pairing, the illumination device assembly can store identification information associated with the second module and can thereafter automatically reconnect with the second module when the illumination device assembly is powered on and brought within communication range. In some implementations, the illumination device assembly can provide a visible pairing confirmation by flashing one or more portions of the at least one LED strip according to a predetermined pattern.

In some embodiments, the illumination device assembly can include a gyroscope, an accelerometer, a magnetometer, or a combination thereof, supported relative to the printed circuit board. In some implementations, the gyroscope, accelerometer, or magnetometer can be configured to detect an unbalanced condition of the helmet indicative of an accident or fall, and upon detection of such condition, the at least one LED strip can be configured to strobe or flash for a duration of available battery life to increase visibility of the wearer. In some embodiments, the illumination device assembly can be further configured to transmit a hazard notification to an external device, such as a paired mobile device or emergency service, upon detection of the unbalanced condition, and in some implementations the hazard notification can be cancellable by the wearer within a predetermined time window to reduce false positives.

In some embodiments, determination of the unbalanced condition can be based on a combination of sensed parameters rather than a single sensor output. For example, the printed circuit board can be configured to evaluate one or more of an angular orientation of the helmet, a rate of change of orientation, an acceleration threshold, a deceleration threshold, an impact event, a sustained non-upright condition, a lack of subsequent motion following a triggering event, or a separation condition between the wearer and an associated vehicle. In this manner, false positive hazard detections caused by routine rider head movement, bumps, or ordinary riding maneuvers can be reduced.

In some embodiments, the illumination device assembly can be configured to be rechargeable via a plug connection, and in some implementations can be configured to be rechargeable via a wireless charging interface. In some embodiments, the illumination device assembly can be configured to provide a visible charging indication, such as flashing of the at least one LED strip, when the battery is being charged.

In some embodiments, the illumination device assembly can be configured to indicate a battery status or operating mode through the at least one LED strip. For example, the printed circuit board can drive the at least one LED strip according to a first pattern indicative of low battery charge, a second pattern indicative of pairing mode, a third pattern indicative of active charging, and a fourth pattern indicative of successful connection with the second module. In some implementations, the illumination device assembly can further be configured to enter a reduced-power mode or sleep mode after a period of inactivity to conserve battery life.

In some embodiments, the illumination device assembly can be provided with installation components that facilitate retrofit mounting to an existing helmet and installation of the second module on an existing vehicle. Such installation components can include one or more surface-preparation wipes, alignment templates, adhesive layers, replacement adhesive layers, splice connectors, clamp connectors, charging cables, and written or digital installation instructions. In some implementations, the illumination device assembly and the second module can be installed by an authorized dealer or service provider to promote proper electrical connection to vehicle wiring and proper placement of the illumination device assembly on the helmet.

In some embodiments, the illumination device assembly can be provided as a kit including the base, the printed circuit board, the battery, the at least one LED strip, the flexible board, the button, the top cover, the at least one screw, the double-sided tape, and the second module including the motorcycle board bottom, the motorcycle printed circuit board, the motorcycle board top, and the hex head screw. In some implementations, the illumination device assembly can be adapted for use with a variety of protective headgear, including motorcycle helmets, bicycle helmets, scooter helmets, and construction or industrial helmets. In some embodiments, the illumination device assembly can be integrally constructed with a helmet such that the base, the printed circuit board, the at least one LED strip, and related components are incorporated into the helmet during manufacture without compromising structural integrity of the helmet.

In one aspect, the disclosure relates to an illumination device assembly configured to be mounted to an exterior surface of a helmet, such as a motorcycle helmet, to enhance rider visibility and signaling. The illumination device assembly includes a base, a printed circuit board, a rechargeable battery, and at least one LED strip extending outwardly from the base. The assembly may further include a user-actuatable button, a flexible board, a cover secured to the base by one or more fasteners, and an adhesive layer, such as double-sided tape, that affixes the base to the helmet without penetrating or structurally modifying the helmet shell.

The printed circuit board may be configured to manage power consumption, including placing the illumination device assembly into a reduced-power or sleep mode following a period of inactivity. In some implementations, the printed circuit board carries a wireless transceiver, such as a Bluetooth® transceiver, enabling wireless communication with one or more external modules or devices. The printed circuit board may be configured to store pairing information and to automatically reconnect with a previously paired external module. Based on signals received wirelessly, the printed circuit board may drive the LED strip to display visual indications corresponding to vehicle operating states or other external inputs.

In certain embodiments, the printed circuit board further carries one or more inertial sensors, such as a gyroscope, accelerometer, magnetometer, or combinations thereof. Signals from the inertial sensor(s) may be used to detect an unbalanced or abnormal condition of the helmet, including conditions determined from one or more parameters such as orientation, changes in orientation, acceleration or deceleration, impact, sustained non-upright positioning, or lack of movement following a triggering event. In response to detection of such a condition, the illumination device assembly may cause the LED strip to flash or strobe. A delay interval may be provided following detection to allow cancellation of a hazard notification. If not cancelled, a hazard notification may be transmitted to an external device, such as a mobile device, wearable device, emergency contact, roadside assistance service, or emergency response service.

In another aspect, the disclosure provides a signaling system that includes both the helmet-mounted illumination device assembly and a vehicle-side module configured to be mounted to a vehicle, such as a motorcycle. The vehicle-side module may include a housing formed by a board bottom and a board top, a printed circuit board disposed within the housing, and fastening elements to secure the housing components together. The vehicle-side printed circuit board may carry a wireless transceiver configured to communicate with the wireless transceiver of the illumination device assembly. In some embodiments, the vehicle-side module is dedicated to a particular illumination device assembly to reduce unintended activation by nearby signaling systems.

The vehicle-side module may be electrically connected to vehicle wiring associated with one or more signaling functions, such as left turn signals, right turn signals, and a brake system, as well as to vehicle power and ground. Electrical connections may be established using splice connectors, clamp-on connectors, soldered connections, or harness adapters. The vehicle-side module may include signal-conditioning circuitry to accommodate vehicle electrical characteristics, including components such as voltage regulators, resistors, diodes, filters, isolation elements, transient protection devices, or overcurrent protection components.

During operation, activation of a left turn signal may cause a corresponding left-side portion of the LED strip to flash, activation of a right turn signal may cause a right-side portion to flash, and application of the vehicle brake system may cause a brake-indication portion of the LED strip to illuminate. If wireless communication between the vehicle-side module and the illumination device assembly is interrupted, the illumination device assembly may continue operating in a default visibility or fallback mode.

In further aspects, the illumination device assembly and vehicle-side module may be provided together as a kit, optionally including installation components such as surface-preparation wipes, alignment templates, replacement adhesive layers, electrical connectors, charging cables, and installation instructions. The vehicle-side module may be affixed within an interior region of the vehicle, such as beneath a seat, using an adhesive layer without requiring structural modification of the vehicle.

The disclosure also contemplates corresponding methods of providing vehicle signaling via a helmet-mounted illumination device, including mounting the illumination device assembly to a helmet using a non-penetrating adhesive, electrically connecting a vehicle-side module to vehicle signaling circuits, wirelessly communicating signals to the helmet-mounted assembly, and driving one or more LED strips to display indications corresponding to operational states of the vehicle or detected hazard conditions.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an exploded perspective view of an illumination device assembly.

FIG. 2 is an exploded perspective view of a motorcycle light kit assembly.

FIG. 3 is an exploded perspective view of portions of a light kit assembly.

FIG. 4 is a perspective view of a printed circuit board.

FIG. 5 is a perspective view of a battery.

FIG. 6 is an exploded perspective view of a motorcycle light assembly including circuit boards and a two-part housing.

FIG. 7 is an exploded perspective view of a light kit assembly showing a base, a top cover, electronics, fasteners, and extending LED strips.

FIG. 8 is an exploded perspective view of a light kit housing assembly including a base, a flexible board support, a top cover, and an adhesive layer.

### DETAILED DESCRIPTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting.

For purposes of reading the description of the various implementations below, the following descriptions of the sections of the Specification and their respective contents may be helpful:

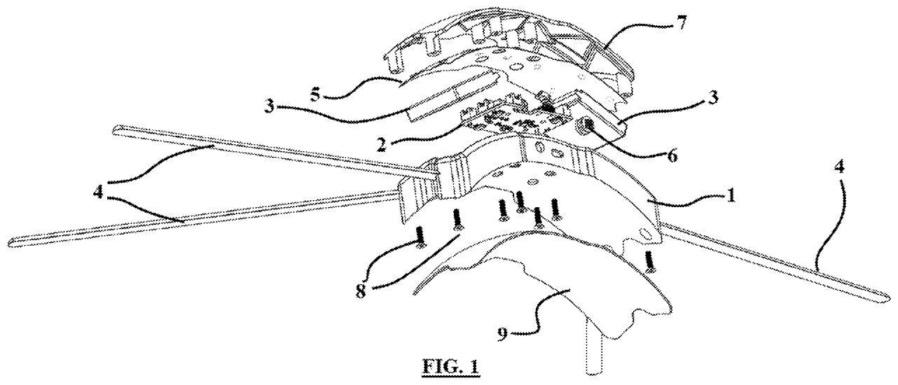

FIG. 1 is an exploded perspective view of an illumination device assembly configured for mounting to a helmet, such as a motorcycle helmet, to provide visual signaling and enhanced visibility to persons and vehicles in the vicinity of a wearer. The illumination device assembly includes a Base 1 that serves as a lower housing structure and principal support for the internal components, a Printed Circuit Board 2 that carries circuitry for operating the assembly, a battery 3 that provides electrical power to the assembly, a LED Strips 4 that emit light outwardly from the assembly, a Flexible Board 5 that supports additional circuitry, a Button 6 that allows user control of the assembly, a Top Cover 7 that encloses the internal components from above, one or more Screws 8 that secure the housing structure together, and a Double-Sided Tape 9 that adheres the assembly to an exterior surface such as an outer shell of a helmet. The components depicted in FIG. 1 are shown in exploded relation along a vertical assembly axis to illustrate the stacked arrangement of the internal electronics between the Base 1 and the Top Cover 7.

In one aspect, the Base 1 defines a contoured lower housing shell shaped to conform to an exterior curvature of a helmet, with the Base 1 having an interior cavity configured to receive and support the internal components of the assembly. The Base 1 includes a plurality of openings arranged along a lower rim thereof that are configured to align with corresponding openings in the Top Cover 7 when the assembly is closed. The Double-Sided Tape 9 is disposed along an underside of the Base 1 and includes an adhesive-bearing layer that can be applied to the outer surface of the helmet to affix the illumination device assembly to the helmet without penetration of, or structural modification to, the helmet shell. In this manner, the structural integrity of the helmet can be preserved while the illumination device assembly is mounted thereto.

According to an embodiment, the Printed Circuit Board 2 is positioned within the interior cavity of the Base 1 and carries electronic components for operating the assembly, which can include a wireless transceiver, a processor, memory, driver circuitry for the LED Strips 4, and, in some embodiments, an inertial sensor such as a gyroscope, accelerometer, or magnetometer. The Flexible Board 5 is supported relative to the Base 1 and extends between the Printed Circuit Board 2 and other components of the assembly to provide electrical interconnections that accommodate the contoured geometry of the housing. The Flexible Board 5 can include conductive traces routed along a bendable substrate, enabling electrical communication across non-planar regions of the assembly and permitting the LED Strips 4 to be energized from the Printed Circuit Board 2.

In some embodiments, the battery 3 is received within the interior cavity of the Base 1 adjacent the Printed Circuit Board 2 and is in electrical communication with the Printed Circuit Board 2 to provide operating power to the circuitry and the LED Strips 4. As shown in FIG. 1, more than one battery 3 can be included in the assembly, with individual batteries positioned on opposite sides of the Printed Circuit Board 2 to distribute mass across the assembly and to provide extended operating duration. The battery 3 can be a rechargeable battery, such as a lithium-ion or lithium-polymer cell, and can be configured to be recharged through a plug connection accessible from an exterior of the assembly or through a wireless charging interface. The Button 6 is supported relative to the Printed Circuit Board 2 and extends through an aperture in the Top Cover 7 such that the Button 6 can be actuated by a user from an exterior of the assembly. Actuation of the Button 6 for a predetermined duration can toggle the assembly between an activated state and a deactivated state.

Furthermore, the LED Strips 4 extend outwardly from the Base 1 along elongated paths and are configured to project visible light away from the helmet when the assembly is mounted thereto. As depicted in FIG. 1, the LED Strips 4 extend laterally from opposite sides of the Base 1 such that, when the assembly is affixed to a rear region of a helmet, the LED Strips 4 can extend along side regions of the helmet to present illumination visible from multiple angles surrounding the wearer. Each of the LED Strips 4 is in electrical communication with the Printed Circuit Board 2 through the Flexible Board 5 and can be controlled to emit a continuous illumination, a flashing illumination, or a strobing illumination depending on operational signals received by the Printed Circuit Board 2. In some embodiments, the LED Strips 4 can be configured to emit white light for general visibility enhancement, and in additional embodiments the LED Strips 4 can emit colored or user-selectable light output. Additionally, a central portion of the LED Strips 4, or a separate light-emitting segment supported relative to a rearward region of the Base 1, can serve as a brake indicator that illuminates in response to a braking signal received by the Printed Circuit Board 2.

In some implementations, earlier versions of the illumination device assembly included additional light-emitting portions positioned along an upper region of the helmet. Subsequent development indicated that a configuration emphasizing side-oriented illumination and a rearward brake indication could provide improved functional distinction between visibility lighting and signaling lighting while reducing battery consumption. For example, removal of an upwardly directed light-emitting portion can reduce emission of light toward non-critical directions and can increase available operating duration of the assembly, while preserving side visibility and rearward brake signaling for nearby drivers.

Likewise, in some development paths, inertial-sensor-based determination of rider turning or braking conditions was considered as a mechanism for controlling helmet-mounted lighting. However, direct acquisition of vehicle turn-signal and brake-system states through the motorcycle light kit assembly can provide improved correspondence between the indication displayed on the helmet and the actual operational state of the vehicle. In this manner, the presently disclosed coordinated signaling system can reduce false activations associated with bumps, rider head movement, or other non-signaling motions while causing the helmet-mounted lighting to mirror the signaling behavior of the vehicle itself.

In some embodiments, the Top Cover 7 overlies the Base 1 and encloses the Printed Circuit Board 2, the battery 3, the Flexible Board 5, and related internal components within the interior cavity defined between the Top Cover 7 and the Base 1. The Top Cover 7 includes a plurality of fastener openings arranged to align with the openings of the Base 1, and the Screws 8 are inserted through the aligned openings to mechanically secure the Top Cover 7 to the Base 1. Each of the Screws 8 can be a threaded fastener that engages corresponding threaded features of the Base 1 to retain the assembly in a closed configuration. The Top Cover 7 can further include a contoured upper surface that conforms to the curvature of the Base 1 to present a low-profile appearance when the assembly is mounted to a helmet, and can include one or more openings or translucent regions to permit passage of light from the LED Strips 4 and access to the Button 6.

In operation, the illumination device assembly can be mounted to a rear region of a helmet such that the Base 1 is adhered to the outer shell of the helmet and the LED Strips 4 extend laterally along opposite side regions of the helmet. When the illumination device assembly is placed in an activated state by the Button 6, the Printed Circuit Board 2 can energize one or more portions of the LED Strips 4 to provide a general visibility illumination. When a wireless signal indicative of activation of a left turn signal is received from the vehicle-side module, a left-side portion of the LED Strips 4 can be driven to flash; when a wireless signal indicative of activation of a right turn signal is received, a right-side portion of the LED Strips 4 can be driven to flash; and when a wireless signal indicative of braking is received, a rearward brake indication portion can be driven to illuminate. In this manner, the illumination device assembly can present signaling that corresponds to operational states of the associated vehicle while elevating the visible indications to the height of the wearer's helmet.

In some embodiments, the illumination device assembly can be configured such that distinct illumination zones are defined along the at least one LED strip. For example, a central or rearward zone can define a brake indication portion, and laterally extending zones on opposite sides of the Base 1 can define left-turn and right-turn indication portions. In some implementations, the zones can be independently controllable by the Printed Circuit Board 2 such that one zone emits steady illumination while another zone flashes or strobes. In additional embodiments, the zones can emit different colors where legally permitted, such as white light for general conspicuity, red light for braking indication, and amber light for directional indication.

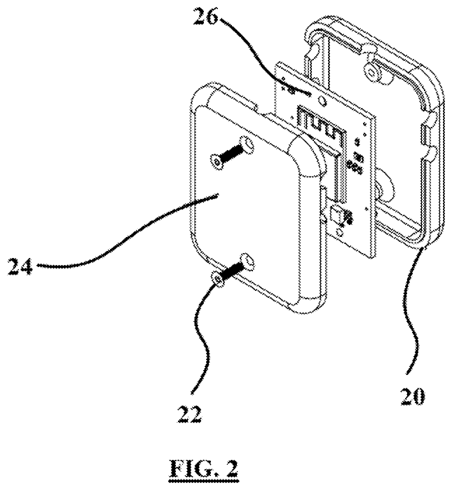

FIG. 2 is an exploded perspective view of a motorcycle light kit assembly configured for installation on a vehicle, such as a motorcycle, and configured to communicate wirelessly with the illumination device assembly described with respect to FIG. 1. The motorcycle light kit assembly depicted in FIG. 2 serves as a vehicle-side module that interfaces with existing electrical systems of the vehicle and transmits operational signals to the helmet-mounted illumination device assembly, such that indicators displayed by the helmet-mounted assembly can be coordinated with the operational state of the vehicle. As shown in FIG. 2, the motorcycle light kit assembly includes a Motorcycle board bottom 20 that defines a lower housing portion of the module, a Motorcycle Printed Circuit Board 22 that carries circuitry for receiving vehicle signals and transmitting corresponding wireless signals, a Motorcycle board top 24 that defines an upper housing portion of the module, and one or more Hex Head Screws 26 that mechanically secure the upper and lower housing portions together. The components depicted in FIG. 2 are shown in exploded relation along an assembly axis to illustrate the stacked arrangement of the Motorcycle Printed Circuit Board 22 between the Motorcycle board bottom 20 and the Motorcycle board top 24.

In one aspect, the Motorcycle board bottom 20 defines a generally rectangular tray-like structure having a peripheral sidewall extending upwardly from a lower floor to form an interior cavity sized to receive the Motorcycle Printed Circuit Board 22. The peripheral sidewall of the Motorcycle board bottom 20 includes a plurality of mounting features, such as threaded bosses or receiving apertures, positioned at corner regions thereof and arranged to align with corresponding fastener openings in the Motorcycle board top 24 when the housing is closed. The Motorcycle board bottom 20 can further include one or more wire-routing openings or pass-throughs formed in the peripheral sidewall to permit passage of electrical conductors from an exterior of the module into the interior cavity, thereby allowing the Motorcycle Printed Circuit Board 22 to be placed in electrical communication with wiring of the vehicle. In some embodiments, an adhesive layer, such as a double-sided tape, can be disposed along an underside of the Motorcycle board bottom 20 to affix the motorcycle light kit assembly to an interior surface of the vehicle, such as a region beneath a seat of the motorcycle, without structural modification of the vehicle.

According to an embodiment, the Motorcycle Printed Circuit Board 22 is disposed within the interior cavity of the Motorcycle board bottom 20 and carries electronic components that enable the motorcycle light kit assembly to function as a vehicle-side communication module. The Motorcycle Printed Circuit Board 22 can include a wireless transceiver, such as a Bluetooth transceiver, configured to transmit signals to a corresponding transceiver carried by the printed circuit board of the helmet-mounted illumination device assembly as described with respect to FIG. 1. The Motorcycle Printed Circuit Board 22 can further include a plurality of signal input terminals, connectors, or splice points configured to receive electrical conductors that can be spliced into existing vehicle wiring associated with a left turn signal, a right turn signal, and a brake system of the vehicle, as well as a power input configured to receive operating power from the vehicle's electrical system. Upon receipt of a turn signal activation, a brake activation, or another operational signal from the vehicle wiring, the Motorcycle Printed Circuit Board 22 can generate a corresponding wireless signal that causes the helmet-mounted illumination device assembly to display a coordinated indication, such as flashing of a side-oriented turn indicator portion of the LED strips or illumination of a brake indicator portion of the LED strips.

In some embodiments, the Motorcycle board top 24 overlies the Motorcycle board bottom 20 and encloses the Motorcycle Printed Circuit Board 22 within the interior cavity defined between the Motorcycle board top 24 and the Motorcycle board bottom 20. The Motorcycle board top 24 includes an upper wall having a plurality of fastener openings extending therethrough and positioned to align with the mounting features of the Motorcycle board bottom 20 when the Motorcycle board top 24 is seated against the peripheral sidewall of the Motorcycle board bottom 20. The Motorcycle board top 24 can further include a contoured outer surface that cooperates with the Motorcycle board bottom 20 to present a low-profile housing envelope that can fit within confined spaces of the vehicle, such as beneath a motorcycle seat. Furthermore, the Motorcycle board top 24 can include one or more interior ribs, standoffs, or retention features configured to engage an upper surface of the Motorcycle Printed Circuit Board 22 to retain the Motorcycle Printed Circuit Board 22 in a stable position against the Motorcycle board bottom 20 when the housing is closed.

Prior to coordinated operation between the motorcycle light kit assembly and the helmet-mounted illumination device assembly, the assemblies can be paired through their respective wireless transceivers. In one implementation, a user can initiate the pairing procedure by actuating the Button 6 according to a predetermined input pattern, after which the Printed Circuit Board 2 enters a pairing mode and searches for a corresponding wireless signal from the Motorcycle Printed Circuit Board 22. Upon successful pairing, identification information associated with the corresponding module can be stored in memory of one or both assemblies, such that the assemblies automatically reconnect during subsequent use without requiring repeated manual pairing. Furthermore, one or more portions of the LED Strips 4 can be flashed according to a confirmation pattern to indicate successful pairing or reconnection.

In some embodiments, the wireless communication link between the helmet-mounted illumination device assembly and the motorcycle light kit assembly can be configured as a dedicated association between a single helmet-mounted assembly and a single vehicle-side module. Such dedicated association can reduce unintended activation by nearby signaling systems and can improve reliability in environments where multiple motorcycles or other vehicles are present. In some implementations, if the wireless link is interrupted, the illumination device assembly can continue operating in a default visibility mode and can attempt reconnection automatically when the corresponding module returns within communication range.

Installation of the motorcycle light kit assembly on the vehicle can be performed by positioning the module beneath a seat of the vehicle, routing electrical conductors of the module toward existing vehicle wiring, and placing selected conductors of the module in electrical communication with vehicle circuits associated with a left turn signal, a right turn signal, a brake system, a power source, and, where appropriate, a ground. In some embodiments, the electrical communication can be established by splice connectors, clamp-on connectors, soldered connections, plug-in harness adapters, or other electrical coupling structures. Once installed, the motorcycle light kit assembly can monitor the state of the corresponding vehicle circuits and can generate wireless signals corresponding to detected turn-signal and braking conditions.

Additionally, each of the Hex Head Screws 26 comprises a threaded fastener having a hex-shaped drive recess formed in a head thereof and a threaded shank extending from the head. The Hex Head Screws 26 are inserted through the fastener openings in the Motorcycle board top 24 and threadedly engage the corresponding mounting features of the Motorcycle board bottom 20 to mechanically secure the Motorcycle board top 24 to the Motorcycle board bottom 20, thereby retaining the Motorcycle Printed Circuit Board 22 within the interior cavity of the assembly. The hex-shaped drive recess of each of the Hex Head Screws 26 can be configured to accept a hex key or similar driver tool, which can facilitate assembly and disassembly of the housing for servicing of the Motorcycle Printed Circuit Board 22 or replacement of internal components. In some embodiments, the Hex Head Screws 26 can be captured within the fastener openings of the Motorcycle board top 24 to reduce the likelihood of fastener loss during assembly or service operations.

Furthermore, the motorcycle light kit assembly shown in FIG. 2 cooperates with the helmet-mounted illumination device assembly of FIG. 1 to form a coordinated signaling system in which operational states of the vehicle are communicated to the wearer's helmet. In some embodiments, activation of a left turn signal of the vehicle causes the Motorcycle Printed Circuit Board 22 to transmit a corresponding wireless signal that causes a left-side portion of the LED strips of the helmet-mounted assembly to flash, activation of a right turn signal of the vehicle causes the Motorcycle Printed Circuit Board 22 to transmit a corresponding wireless signal that causes a right-side portion of the LED strips to flash, and application of a brake of the vehicle causes the Motorcycle Printed Circuit Board 22 to transmit a corresponding wireless signal that causes a brake indication portion of the LED strips to illuminate. In this manner, the motorcycle light kit assembly enables the helmet-mounted indicators to mirror the operational state of the vehicle's turn signals and brake system, thereby providing visible signaling from the helmet of the wearer that corresponds to the signaling presented by the vehicle itself.

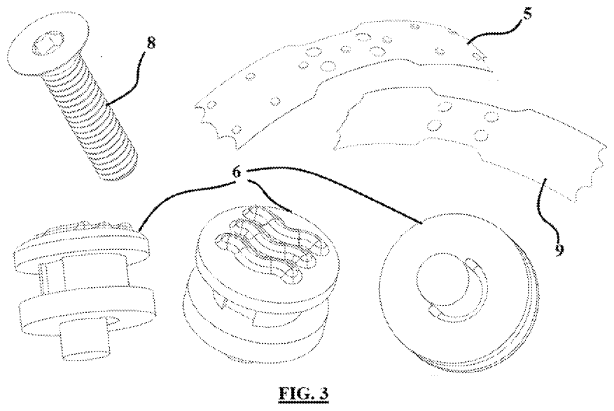

FIG. 3 is an exploded perspective view of portions of a light kit assembly, illustrating selected components of the illumination device assembly described with respect to FIG. 1 in greater detail and in an exploded relationship that reveals their individual geometries and mutual interfaces. In particular, FIG. 3 depicts the Flexible Board 5, the Button 6, the Screw 8, and the Double-Sided Tape 9, which cooperate within the broader illumination device assembly to provide user actuation, internal electrical interconnection, mechanical closure of the housing, and adhesive attachment of the assembly to an exterior surface such as an outer shell of a helmet. The components shown in FIG. 3 are illustrated separated from the remaining elements of the illumination device assembly to facilitate description of their structural features and functional interactions.

In one aspect, the Flexible Board 5 is shown in FIG. 3 as a thin, elongated, contoured substrate having a curvilinear outline that follows a lateral contour of the illumination device assembly when the assembly is in a closed configuration. The Flexible Board 5 includes an array of openings distributed along a surface thereof, which can serve as mounting locations for discrete light-emitting elements, as pass-throughs for conductive interconnections, or as weight-reducing apertures that enhance flexibility of the substrate. The contoured outline of the Flexible Board 5 enables the substrate to follow non-planar regions of the assembly and to extend along lateral portions of the base described with respect to FIG. 1, thereby permitting electrical signals and power to be routed from the printed circuit board to the LED strips across curved regions of the housing. The Flexible Board 5 can include conductive traces disposed along a bendable dielectric layer, with the apertures providing locations for soldered connections, plated vias, or mechanical registration features that align the Flexible Board 5 with other internal components during assembly.

According to an embodiment, the Button 6 is depicted in FIG. 3 as a multi-part actuator assembly comprising an upper actuator cap, an intermediate actuator body, and a lower support portion. The upper actuator cap of the Button 6 includes a contoured upper surface shaped for tactile engagement by a user's finger and is configured to be accessible through an opening in the top cover of the illumination device assembly. The intermediate actuator body of the Button 6 includes a sidewall having one or more retention features, such as surface contours or keyed regions, that engage a corresponding opening of the top cover to retain the Button 6 in a seated position while permitting axial travel of the actuator cap during user actuation. The lower support portion of the Button 6 extends downwardly toward the printed circuit board and is positioned to transmit actuation force from the upper actuator cap to a switch element carried by the printed circuit board. Furthermore, the Button 6 can be configured such that a press-and-hold actuation for a predetermined duration toggles the illumination device assembly between an activated state and a deactivated state, while a shorter actuation can be reserved for other input functions such as mode selection or pairing initiation.

In some embodiments, the Screw 8 is depicted in FIG. 3 as a threaded fastener comprising a head portion having a drive recess formed therein and a threaded shank extending axially from the head portion. The drive recess of the Screw 8 can be configured to receive a corresponding driver tool, such as a hex key, to facilitate controlled application of torque during installation and removal. The threaded shank of the Screw 8 is sized and threaded to engage a corresponding threaded feature formed in the base of the illumination device assembly, such that insertion of the Screw 8 through an aligned opening in the top cover and engagement of the threaded shank with the threaded feature of the base mechanically secures the top cover to the base. The head portion of the Screw 8 can include a countersunk, pan, or button profile that seats substantially flush with or slightly recessed relative to an outer surface of the top cover, thereby providing a low-profile external appearance that reduces snag points and contributes to a streamlined envelope of the illumination device assembly when mounted to a helmet.

Furthermore, the Double-Sided Tape 9 is depicted in FIG. 3 as a flexible, contoured adhesive layer having an outline that corresponds to the footprint of the base of the illumination device assembly described with respect to FIG. 1. The Double-Sided Tape 9 includes a first adhesive-bearing face configured to adhere to an underside of the base and an opposing second adhesive-bearing face configured to adhere to an exterior surface, such as an outer shell of a helmet. The Double-Sided Tape 9 can include a carrier layer disposed between the first and second adhesive-bearing faces to provide dimensional stability to the adhesive layer and to accommodate the curved contour of the exterior surface to which the assembly is mounted. The Double-Sided Tape 9 can further include one or more release liners covering the adhesive-bearing faces prior to installation, which can be removed at the time of installation to expose the adhesive and enable attachment of the illumination device assembly to the helmet. Additionally, by providing adhesive attachment through the Double-Sided Tape 9, the illumination device assembly can be affixed to the helmet without penetration of the helmet shell, such that the structural integrity of the helmet is preserved during installation and use of the illumination device assembly.

Additionally, the components shown in FIG. 3 cooperate to complete the mechanical and electrical architecture of the illumination device assembly. The Flexible Board 5 provides electrical interconnection between the printed circuit board and the LED strips across the curved internal geometry of the housing, the Button 6 provides a user-actuatable input that can be pressed through the top cover to control operational states of the assembly, the Screw 8 mechanically secures the top cover to the base to enclose the internal electronics, and the Double-Sided Tape 9 affixes the closed assembly to an exterior surface such as a helmet shell. Furthermore, the components depicted in FIG. 3 can be provided as part of a kit together with the remaining components of the illumination device assembly described with respect to FIG. 1 and the motorcycle light kit assembly described with respect to FIG. 2, such that a user or installer can assemble the illumination device assembly, mount the assembly to a helmet using the Double-Sided Tape 9, and pair the assembly with a vehicle-side module to provide coordinated signaling functionality.

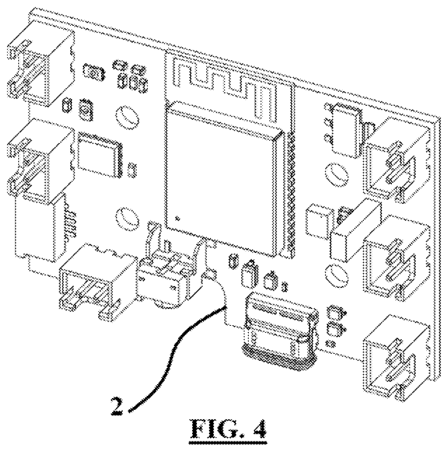

FIG. 4 is a perspective view of a Printed Circuit Board 2 of the illumination device assembly described with respect to FIG. 1, illustrating the Printed Circuit Board 2 in greater detail to show the arrangement of electronic components carried thereon. The Printed Circuit Board 2 serves as a central electrical and control platform of the illumination device assembly and carries circuitry for managing operational states of the assembly, driving the LED strips, communicating wirelessly with the motorcycle light kit assembly described with respect to FIG. 2, and interfacing with the battery, the flexible board, and the button. The Printed Circuit Board 2 is depicted in FIG. 4 in a populated configuration, with discrete electronic components, connectors, and integrated modules disposed along an upper surface of a rigid substrate that defines the structural body of the Printed Circuit Board 2.

In one aspect, the Printed Circuit Board 2 comprises a generally planar rigid substrate having a rectangular outline and including a plurality of conductive traces routed along and through the substrate to interconnect the electronic components carried thereon. The substrate of the Printed Circuit Board 2 includes one or more mounting apertures extending therethrough, which can receive fasteners or alignment posts to retain the Printed Circuit Board 2 in a seated position within the interior cavity of the base described with respect to FIG. 1. The rectangular outline of the Printed Circuit Board 2 is sized to correspond to the interior cavity of the base, such that the Printed Circuit Board 2 can be received within the base with lateral edges of the Printed Circuit Board 2 positioned adjacent interior sidewalls of the base, thereby permitting electrical conductors extending from the Printed Circuit Board 2 to reach the LED strips, the flexible board, the battery, and the button without excessive routing distance.

According to an embodiment, the Printed Circuit Board 2 carries a wireless communication module disposed on a central region of the upper surface thereof, the wireless communication module comprising an integrated transceiver package having an antenna region configured to transmit and receive wireless signals. The wireless communication module of the Printed Circuit Board 2 is configured to establish a wireless link, such as a Bluetooth link, with a corresponding wireless transceiver carried by the motorcycle printed circuit board of the motorcycle light kit assembly described with respect to FIG. 2. Through the wireless communication module, the Printed Circuit Board 2 can receive signals indicative of operational states of the vehicle, such as activation of a left turn signal, activation of a right turn signal, or application of a brake, and can responsively generate drive signals that cause corresponding portions of the LED strips to flash, strobe, or illuminate. Additionally, the wireless communication module can support pairing operations between the Printed Circuit Board 2 and the motorcycle light kit assembly, such that the illumination device assembly can be associated with a particular vehicle-side module during an initial setup procedure.

In some embodiments, the Printed Circuit Board 2 carries a plurality of connector receptacles disposed along peripheral regions of the upper surface thereof, the connector receptacles being configured to receive mating connectors of electrical conductors that extend to the LED strips, the flexible board, and the battery. As shown in FIG. 4, the Printed Circuit Board 2 can include a first set of connector receptacles disposed along a first lateral edge of the substrate and a second set of connector receptacles disposed along a second lateral edge of the substrate opposite the first lateral edge, with the connector receptacles being arranged to accommodate electrical connections to components positioned on opposite sides of the Printed Circuit Board 2 within the base. The connector receptacles can include polarized keying features that prevent reverse insertion of mating connectors and can include retention features that resist inadvertent disconnection of the electrical conductors during use of the illumination device assembly. Furthermore, a central connector disposed along a lower region of the upper surface of the Printed Circuit Board 2 can be configured to receive a mating connector of the flexible board described with respect to FIG. 1, thereby placing the Printed Circuit Board 2 in electrical communication with the flexible board and, through the flexible board, with additional components of the illumination device assembly.

Furthermore, the Printed Circuit Board 2 carries a plurality of discrete electronic components, including resistors, capacitors, inductors, diodes, and integrated circuits, distributed across the upper surface of the substrate to implement power regulation, signal conditioning, and driver circuitry for the LED strips. A power management region of the Printed Circuit Board 2 can include circuitry configured to receive direct-current power from the battery described with respect to FIG. 1, regulate the direct-current power to one or more operating voltages suitable for the wireless communication module and the LED driver circuitry, and manage charging of the battery when an external charging source is connected to the illumination device assembly. In some embodiments, the Printed Circuit Board 2 can further carry an inertial sensor, such as a gyroscope, an accelerometer, or a magnetometer, or a combination thereof, configured to detect movement or orientation of the illumination device assembly and to provide corresponding signals to a processor carried by the Printed Circuit Board 2. Upon detection of a condition indicative of an unbalanced state of the helmet, such as a fall or accident, the processor of the Printed Circuit Board 2 can generate drive signals that cause the LED strips to strobe or flash for a duration of available battery life, thereby increasing visibility of the wearer in the event of an accident.

In some embodiments, detection of an unbalanced condition can initiate a staged hazard response process. For example, upon detection of a condition satisfying one or more hazard criteria, the Printed Circuit Board 2 can first cause the LED Strips 4 to strobe and can initiate a delay interval during which the wearer is permitted to cancel an external hazard notification. If the hazard condition is not cancelled within the delay interval, the illumination device assembly can transmit a hazard signal to a paired external device, such as a mobile phone, wearable device, roadside assistance platform, emergency contact, or emergency response service. Such staged response can reduce false positive emergency notifications while preserving the ability to provide automatic assistance when a significant event has occurred.

In some implementations, cancellation of the hazard notification can be performed through actuation of the Button 6, through input to a paired mobile device, or through input to a paired wearable device. In additional embodiments, the hazard criteria can be based on a combination of orientation data, acceleration data, impact detection, elapsed time without subsequent movement, or relative position data indicative of separation between the helmet and the vehicle. The use of multiple criteria can improve differentiation between an actual accident condition and ordinary handling of the helmet when the wearer is not in distress.

Additionally, the Printed Circuit Board 2 carries a switch element positioned to be actuated by the button described with respect to FIG. 1, the switch element being disposed along the upper surface of the Printed Circuit Board 2 at a location aligned with the lower support portion of the button when the illumination device assembly is in a closed configuration. Actuation of the switch element through a press-and-hold operation of the button for a predetermined duration can cause the Printed Circuit Board 2 to toggle between an activated state and a deactivated state, and additional actuation patterns, such as shorter presses or multiple presses, can be used to initiate pairing operations, select operational modes, or trigger other input functions supported by the circuitry carried on the Printed Circuit Board 2. Furthermore, the Printed Circuit Board 2 can include a charging interface, such as a plug-receiving receptacle or a wireless charging coil coupled to the substrate, through which the battery can be recharged, and the Printed Circuit Board 2 can be configured to cause the LED strips to flash or otherwise provide a visible indication that charging is in progress when the charging interface is energized by an external charging source.

In some embodiments, the Printed Circuit Board 2 can be configured to monitor a charge state of the battery 3 and to generate one or more visible indications corresponding to the monitored charge state. For example, when the charge state falls below a threshold value, the Printed Circuit Board 2 can cause one or more portions of the LED Strips 4 to flash according to a low-battery pattern or can reduce brightness of non-essential illumination zones to preserve signaling functionality for a longer duration. In some implementations, the Printed Circuit Board 2 can automatically transition the illumination device assembly into a reduced-power mode after a predetermined period of inactivity.

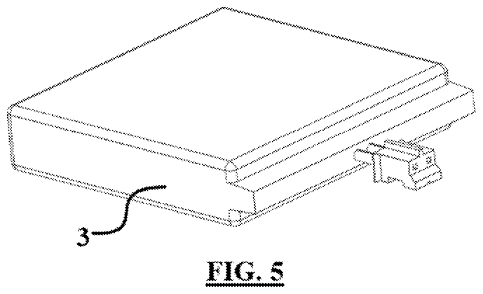

FIG. 5 is a perspective view of a battery 3 of the illumination device assembly described with respect to FIG. 1, illustrating the battery 3 in greater detail to show the external geometry of the power source and its electrical interconnection to the printed circuit board. The battery 3 serves as the portable energy storage element of the illumination device assembly and provides operating power to the circuitry carried by the printed circuit board, the LED strips, the flexible board, and the wireless communication module. As depicted in FIG. 5, the battery 3 includes a generally rectangular cell body and a connector assembly extending from a sidewall of the cell body, with the connector assembly terminating in a mating plug that is configured to engage a corresponding connector receptacle carried by the printed circuit board.

In one aspect, the battery 3 comprises a generally rectangular prismatic cell body having an upper face, a lower face opposite the upper face, and four peripheral sidewalls extending between the upper face and the lower face to define an enclosed volume that houses electrochemical cell contents. The cell body of the battery 3 presents a thin-profile form factor in which a thickness of the cell body as measured between the upper face and the lower face is less than a lateral dimension of the cell body as measured across either the upper face or the lower face, thereby enabling the battery 3 to be received within the interior cavity of the base described with respect to FIG. 1 without adding excessive bulk to the illumination device assembly when the assembly is mounted to a helmet. The peripheral sidewalls of the cell body can include radiused corner regions that facilitate placement of the battery 3 against interior sidewalls of the base and can reduce stress concentrations at the corners of the cell body during handling and installation.

According to an embodiment, the battery 3 is configured as a rechargeable lithium-based cell, such as a lithium-ion cell or a lithium-polymer cell, and includes electrochemical cell contents enclosed within a sealed pouch or rigid housing that defines the cell body. The rechargeable configuration of the battery 3 enables the illumination device assembly to be recharged through a charging interface carried by the printed circuit board described with respect to FIG. 4, such that the battery 3 can be reused across multiple operating cycles without replacement of the cell. In additional embodiments, the battery 3 can comprise other rechargeable cell chemistries or can comprise a replaceable primary cell, and in some implementations more than one battery 3 can be provided within the illumination device assembly, with individual cells positioned on opposite sides of the printed circuit board to distribute mass across the assembly and to extend operating duration of the illumination device assembly between charging cycles.

In some embodiments, the battery 3 includes a connector assembly extending outwardly from one of the peripheral sidewalls of the cell body, the connector assembly comprising a pair of electrical conductors routed from internal terminals of the cell body to an externally accessible mating plug. The electrical conductors of the connector assembly can include a positive conductor and a negative conductor that carry direct-current power from the electrochemical cell contents of the battery 3 to the mating plug, and the conductors can be bundled, insulated, or sheathed along a length thereof to protect the conductors during installation and use of the illumination device assembly. The mating plug of the connector assembly includes a housing body supporting electrical contacts that align with corresponding contacts of the connector receptacle carried by the printed circuit board, such that insertion of the mating plug into the connector receptacle places the battery 3 in electrical communication with the printed circuit board and enables the battery 3 to supply operating power to the circuitry carried thereon.

In some embodiments, circuitry of the internal circuit board arrangement of the motorcycle light assembly can include signal-conditioning circuitry configured to accommodate electrical characteristics of different vehicle platforms. For example, the circuitry can include one or more voltage regulators, resistors, diodes, filtering elements, isolation components, transient protection components, or overcurrent protection components that enable reliable detection of vehicle signaling states while protecting the internal circuit board arrangement from electrical noise, vibration-related disturbances, and transient conditions present in vehicle electrical systems.

Furthermore, the mating plug of the battery 3 can include polarized keying features that prevent reverse insertion of the mating plug into the connector receptacle of the printed circuit board, thereby reducing the likelihood of incorrect polarity being applied to the circuitry during installation or replacement of the battery 3. The mating plug can further include retention features, such as latching tabs or friction-fit surfaces, that resist inadvertent disconnection of the battery 3 from the printed circuit board during use of the illumination device assembly, such that the electrical connection between the battery 3 and the printed circuit board is maintained when the illumination device assembly is subjected to vibration, impact, or other forces encountered during riding. Additionally, the externally accessible nature of the mating plug enables the battery 3 to be disconnected from the printed circuit board for servicing or replacement of the cell, such as in the event that the electrochemical cell contents of the battery 3 reach the end of their service life, without disassembly of the entire illumination device assembly.

Additionally, the battery 3 cooperates with the printed circuit board described with respect to FIG. 4 to enable the power management and charging functions of the illumination device assembly. In one aspect, when the mating plug of the battery 3 is engaged with the corresponding connector receptacle of the printed circuit board, direct-current power from the battery 3 can be routed through power regulation circuitry carried by the printed circuit board and distributed to the wireless communication module, the LED driver circuitry, and the inertial sensor, where present. Furthermore, when an external charging source is connected to the charging interface of the printed circuit board, charging current can be routed from the charging interface through the power management circuitry and through the connector receptacle and mating plug to the battery 3, thereby replenishing the electrochemical cell contents of the battery 3 for subsequent operating cycles. During charging of the battery 3, the printed circuit board can drive the LED strips to flash or otherwise provide a visible indication that charging is in progress, allowing a user to visually confirm that the battery 3 is receiving charging current from the external charging source.

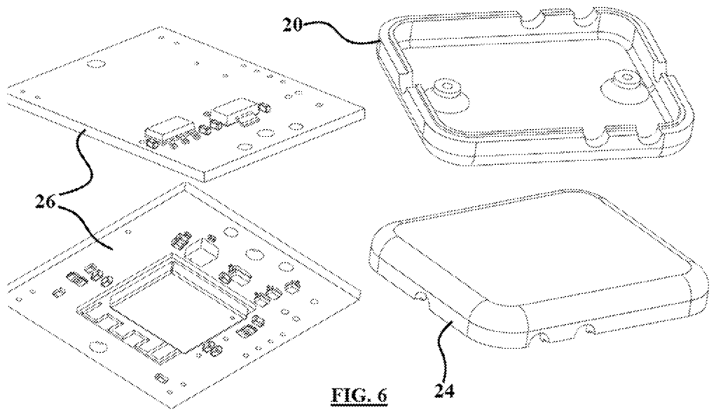

FIG. 6 is an exploded perspective view of a motorcycle light assembly including circuit boards and a two-part housing, illustrating in greater detail the physical arrangement of the housing components and the internal circuit board architecture of the motorcycle light kit assembly described with respect to FIG. 2. The motorcycle light assembly depicted in FIG. 6 serves as the vehicle-side module of the coordinated signaling system and is configured for placement within a confined interior region of a vehicle, such as beneath a seat of a motorcycle, where the module can interface with existing vehicle wiring and transmit wireless signals to the helmet-mounted illumination device assembly described with respect to FIG. 1. As shown in FIG. 6, the motorcycle light assembly includes a Motorcycle board bottom 20 that defines a lower housing portion, a Motorcycle board top 24 that defines an upper housing portion, and one or more Hex Head Screws 26 that mechanically secure the upper housing portion to the lower housing portion. FIG. 6 further depicts an internal circuit board arrangement disposed between the Motorcycle board bottom 20 and the Motorcycle board top 24, the internal circuit board arrangement including a first circuit board carrying discrete electronic components on an upper surface thereof and a second circuit board positioned below the first circuit board and carrying additional electronic components and connector features.

In one aspect, the Motorcycle board bottom 20 is depicted in FIG. 6 as a generally rectangular frame-like structure having a peripheral sidewall that extends upwardly from a lower floor region to form an interior cavity sized to receive the internal circuit board arrangement. The peripheral sidewall of the Motorcycle board bottom 20 defines an open upper region through which the internal circuit board arrangement can be introduced during assembly of the module, and includes a plurality of mounting features, such as threaded bosses, positioned at interior corner regions of the peripheral sidewall. The threaded bosses of the Motorcycle board bottom 20 extend upwardly from the lower floor region and are configured to receive threaded shanks of the Hex Head Screws 26 when the housing is closed. Furthermore, the peripheral sidewall of the Motorcycle board bottom 20 can include one or more wire-routing openings or notches formed along an upper edge thereof to permit passage of electrical conductors from an exterior of the module into the interior cavity, thereby allowing the internal circuit board arrangement to be placed in electrical communication with wiring of the vehicle, including wiring associated with a left turn signal, a right turn signal, and a brake system of the vehicle. The lower floor region of the Motorcycle board bottom 20 can present a contoured lower surface that conforms to a mounting location on the vehicle, and in some embodiments an adhesive layer can be disposed along the contoured lower surface to affix the motorcycle light assembly to an interior region of the vehicle without structural modification thereof.

According to an embodiment, the internal circuit board arrangement shown in FIG. 6 comprises two cooperating circuit boards that together implement the functionality of the motorcycle printed circuit board described with respect to FIG. 2. A first circuit board of the internal circuit board arrangement is depicted in FIG. 6 as a generally planar rectangular substrate having a plurality of mounting apertures distributed along peripheral regions thereof and carrying discrete electronic components on an upper surface thereof, the discrete electronic components including integrated circuit packages, passive components, and signal conditioning elements that implement wireless communication, power regulation, and signal processing functions of the module. A second circuit board of the internal circuit board arrangement is positioned below the first circuit board and is depicted as a generally planar rectangular substrate having a central recess or opening formed therein, the central recess being sized to accommodate a component extending from an underside of the first circuit board when the first circuit board is seated against the second circuit board. The second circuit board carries a plurality of connector features distributed around a periphery of the central recess, the connector features being configured to receive mating connectors of electrical conductors that extend from the vehicle wiring into the interior cavity of the Motorcycle board bottom 20. Furthermore, the mounting apertures of the first circuit board can align with the connector features of the second circuit board and with the threaded bosses of the Motorcycle board bottom 20 when the internal circuit board arrangement is seated within the interior cavity, such that the Hex Head Screws 26 can pass through aligned openings in the first circuit board and engage the threaded bosses of the Motorcycle board bottom 20 to retain the internal circuit board arrangement in a stable position.

In some embodiments, the Motorcycle board top 24 is depicted in FIG. 6 as a cover member having a contoured upper wall and a peripheral lip extending downwardly from the contoured upper wall, with the peripheral lip being sized and shaped to seat against an upper edge of the peripheral sidewall of the Motorcycle board bottom 20 when the housing is closed. The contoured upper wall of the Motorcycle board top 24 presents a rounded, low-profile outer surface that cooperates with the peripheral sidewall of the Motorcycle board bottom 20 to define an enclosed housing envelope suitable for placement within confined interior regions of the vehicle, such as beneath a motorcycle seat. The peripheral lip of the Motorcycle board top 24 can include one or more cutouts or reliefs formed along lower edges thereof to accommodate the wire-routing openings or notches of the Motorcycle board bottom 20, such that electrical conductors extending into the interior cavity are not pinched or damaged when the Motorcycle board top 24 is seated against the Motorcycle board bottom 20. Additionally, the Motorcycle board top 24 can include interior retention features, such as ribs or standoffs extending downwardly from the contoured upper wall, configured to engage the upper surface of the first circuit board of the internal circuit board arrangement and retain the internal circuit board arrangement in a stable position against the Motorcycle board bottom 20 when the housing is closed.

Furthermore, each of the Hex Head Screws 26 comprises a threaded fastener having a head portion with a hex-shaped drive recess formed therein and a threaded shank extending axially from the head portion. The Hex Head Screws 26 are configured to pass through the mounting apertures of the first circuit board of the internal circuit board arrangement and to threadedly engage the threaded bosses of the Motorcycle board bottom 20, thereby mechanically securing the internal circuit board arrangement within the interior cavity of the Motorcycle board bottom 20. In some embodiments, the Hex Head Screws 26 can additionally pass through corresponding openings in the peripheral lip of the Motorcycle board top 24 prior to engaging the threaded bosses of the Motorcycle board bottom 20, such that the same set of Hex Head Screws 26 simultaneously secures the Motorcycle board top 24 to the Motorcycle board bottom 20 and retains the internal circuit board arrangement within the interior cavity. The hex-shaped drive recess of each of the Hex Head Screws 26 can be configured to accept a hex key or similar driver tool, which can facilitate controlled application of torque during installation and removal of the Hex Head Screws 26 and can permit disassembly of the housing for servicing of the internal circuit board arrangement.

Additionally, the arrangement of the Motorcycle board bottom 20, the internal circuit board arrangement, the Motorcycle board top 24, and the Hex Head Screws 26 shown in FIG. 6 cooperates with the helmet-mounted illumination device assembly described with respect to FIG. 1 to form the coordinated signaling system described with respect to FIG. 2. In one aspect, the discrete electronic components carried on the upper surface of the first circuit board of the internal circuit board arrangement can include a wireless transceiver, such as a Bluetooth transceiver, that establishes a wireless link with a corresponding transceiver carried by the printed circuit board described with respect to FIG. 4. Electrical conductors extending from the vehicle wiring can be routed through the wire-routing openings of the Motorcycle board bottom 20 and can be engaged with the connector features carried on the second circuit board of the internal circuit board arrangement, thereby placing the internal circuit board arrangement in electrical communication with the left turn signal, the right turn signal, the brake system, and a power source of the vehicle. Upon receipt of a signal indicative of activation of a turn signal or application of a brake of the vehicle, the internal circuit board arrangement can generate a corresponding wireless signal that is transmitted through the wireless transceiver to the helmet-mounted illumination device assembly, such that a coordinated indication is displayed by the LED strips of the helmet-mounted illumination device assembly in correspondence with the operational state of the vehicle. Furthermore, the two-part housing formed by the Motorcycle board bottom 20 and the Motorcycle board top 24 and secured by the Hex Head Screws 26 encloses and protects the internal circuit board arrangement from environmental conditions encountered beneath the seat of the vehicle, including vibration, moisture, and debris, thereby contributing to reliable operation of the motorcycle light assembly over extended service intervals.

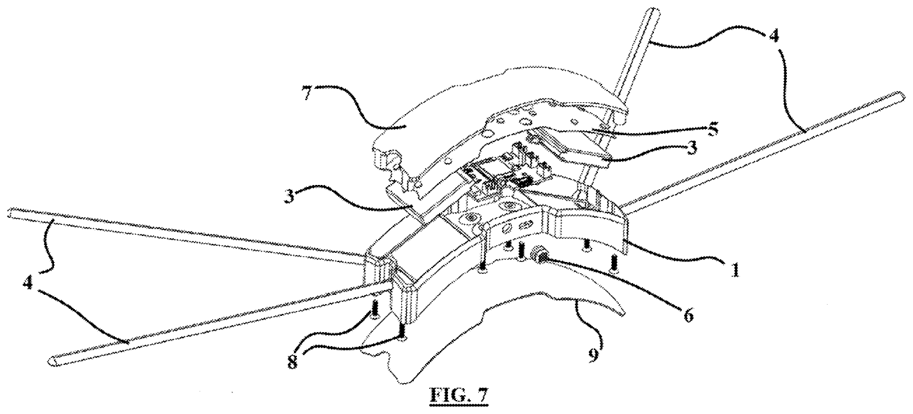

FIG. 7 is an exploded perspective view of a light kit assembly showing the arrangement of housing components, internal electronics, fasteners, and elongated light-emitting elements of the illumination device assembly described with respect to FIG. 1. The light kit assembly depicted in FIG. 7 is configured for mounting to an exterior surface of a helmet, such as a rear region of a motorcycle helmet, and presents the internal architecture of the assembly in a separated relationship that reveals the stacked arrangement of the Base 1, the battery 3, the Flexible Board 5, the Button 6, the Top Cover 7, the Screws 8, the Double-Sided Tape 9, and the LED Strips 4 extending outwardly from the assembly along opposite lateral directions. The components illustrated in FIG. 7 cooperate to form a low-profile housing envelope that encloses the internal electronics while presenting elongated light-emitting paths that extend laterally away from the central housing when the assembly is installed on a helmet.

In one aspect, the Base 1 is depicted in FIG. 7 as a contoured lower housing shell that defines an interior cavity sized to receive and support the internal components of the illumination device assembly. The Base 1 presents a peripheral rim region extending around the interior cavity, with the peripheral rim region including a plurality of fastener-receiving features distributed at spaced-apart locations along the rim. The fastener-receiving features of the Base 1 are positioned to align with corresponding openings in the Top Cover 7 when the housing is closed, such that the Screws 8 can pass through the aligned openings to mechanically secure the Top Cover 7 to the Base 1. Furthermore, the Base 1 includes a plurality of lateral channel regions extending outwardly from opposite sides of the interior cavity, the lateral channel regions being shaped to receive proximal ends of the LED Strips 4 and to guide the LED Strips 4 outwardly from the housing along generally horizontal paths when the assembly is mounted to a helmet.

According to an embodiment, the battery 3 is shown in FIG. 7 as a thin-profile cell body received within the interior cavity of the Base 1 and positioned beneath the Flexible Board 5. As depicted in FIG. 7, more than one battery 3 can be disposed within the interior cavity of the Base 1, with individual cells positioned at spaced-apart locations along the interior cavity to distribute mass across the assembly and to provide extended operating duration for the illumination device assembly. The battery 3 is in electrical communication with circuitry carried within the housing and provides direct-current operating power to the LED Strips 4, the Flexible Board 5, and related circuitry. In some embodiments, the battery 3 comprises a rechargeable lithium-based cell, such as a lithium-ion or lithium-polymer cell, and can be recharged through a charging interface accessible from an exterior of the housing.

In some embodiments, the Flexible Board 5 is depicted in FIG. 7 as a thin, elongated substrate disposed above the battery 3 within the interior cavity of the Base 1 and extending along a lateral contour of the housing. The Flexible Board 5 carries a plurality of electronic components along an upper surface thereof, the electronic components including connector features, integrated circuit packages, and conductive traces that route electrical signals between the battery 3, the LED Strips 4, and the Button 6. The Flexible Board 5 can include a bendable dielectric layer that enables the substrate to follow non-planar regions of the Base 1, such that electrical interconnections can extend across curved portions of the housing without requiring rigid routing paths. Furthermore, the Flexible Board 5 includes lateral extension regions that extend toward the lateral channel regions of the Base 1 and that terminate at connection points configured to engage proximal ends of the LED Strips 4, thereby placing the LED Strips 4 in electrical communication with the circuitry carried by the Flexible Board 5.

Furthermore, the LED Strips 4 are illustrated in FIG. 7 as elongated light-emitting members extending outwardly from opposite sides of the Base 1 along generally linear paths. A first pair of the LED Strips 4 extends outwardly from a first lateral side of the Base 1 and a second pair of the LED Strips 4 extends outwardly from an opposite second lateral side of the Base 1, such that the LED Strips 4 can extend along side regions of a helmet when the assembly is affixed to a rear region of the helmet. Each of the LED Strips 4 comprises an elongated substrate carrying a series of light-emitting diodes distributed along a length thereof, with proximal ends of the LED Strips 4 being received within the lateral channel regions of the Base 1 and placed in electrical communication with the Flexible Board 5. The LED Strips 4 can be driven by circuitry carried within the housing to emit continuous illumination, flashing illumination indicative of a turn signal activation of an associated vehicle, or strobing illumination indicative of an unbalanced condition detected by an inertial sensor carried within the housing.

Additionally, the Button 6 is depicted in FIG. 7 as an actuator element supported along a forward sidewall region of the Base 1 and accessible from an exterior of the housing when the assembly is in a closed configuration. The Button 6 extends through an opening formed in the forward sidewall region of the Base 1 and is positioned to be engaged by a user's finger to toggle the illumination device assembly between an activated state and a deactivated state. Actuation of the Button 6 for a predetermined duration, such as a press-and-hold operation, can cause the circuitry carried within the housing to transition between the activated state and the deactivated state, while additional actuation patterns can initiate pairing operations with a vehicle-side module as described with respect to FIG. 2 or select among operational modes supported by the circuitry. The Button 6 is positioned at a location on the Base 1 that is accessible by a user when the assembly is mounted to a helmet, thereby permitting the user to control operational states of the assembly without removal of the helmet.

In one aspect, the Top Cover 7 is shown in FIG. 7 positioned above the Base 1 in an exploded relationship and configured to be seated against the peripheral rim region of the Base 1 to enclose the internal components within the interior cavity. The Top Cover 7 presents a contoured upper surface that conforms to the curvature of the Base 1 and includes a plurality of fastener openings extending therethrough, with the fastener openings being positioned to align with the fastener-receiving features of the Base 1 when the Top Cover 7 is seated thereagainst. The Top Cover 7 can further include an aperture formed at a forward region thereof that is sized and positioned to accommodate the Button 6 when the housing is closed, thereby permitting the Button 6 to remain accessible from an exterior of the assembly. Furthermore, the Top Cover 7 can include one or more translucent regions or openings that permit passage of light from the LED Strips 4 or from indicator elements carried on the Flexible Board 5 through the Top Cover 7 to an exterior of the assembly.

According to an embodiment, the Screws 8 are depicted in FIG. 7 as threaded fasteners arranged in an exploded configuration below the Base 1 and configured to be inserted upwardly through the fastener-receiving features of the Base 1 to engage corresponding threaded features of the Top Cover 7. Each of the Screws 8 includes a head portion with a drive recess formed therein and a threaded shank extending axially from the head portion, with the threaded shank being sized to engage a threaded feature of the Top Cover 7 to mechanically draw the Top Cover 7 and the Base 1 together. The Screws 8 are distributed at spaced-apart locations along the peripheral rim region of the Base 1 to provide distributed clamping force around the perimeter of the housing, thereby retaining the Top Cover 7 in a seated position against the Base 1 and enclosing the battery 3, the Flexible Board 5, and related internal components within the interior cavity. Furthermore, the drive recess of each of the Screws 8 can be configured to accept a hex key or similar driver tool to facilitate controlled application of torque during installation and disassembly of the housing.

In some embodiments, the Double-Sided Tape 9 is illustrated in FIG. 7 as a contoured adhesive layer disposed beneath the Base 1 in an exploded relationship and configured to adhere an underside of the Base 1 to an exterior surface, such as an outer shell of a helmet. The Double-Sided Tape 9 presents an outline that corresponds to the footprint of the underside of the Base 1 and includes a first adhesive-bearing face configured to engage the underside of the Base 1 and an opposing second adhesive-bearing face configured to engage the exterior surface of the helmet. The Double-Sided Tape 9 can include a carrier layer disposed between the first and second adhesive-bearing faces to provide dimensional stability to the adhesive layer and to accommodate curved contours of the helmet shell, and can include one or more release liners covering the adhesive-bearing faces prior to installation. Additionally, by affixing the illumination device assembly to the helmet through the Double-Sided Tape 9, the assembly can be mounted to the helmet without penetration of, or mechanical fastening into, the helmet shell, such that the structural integrity of the helmet is preserved during installation and use of the illumination device assembly.

Furthermore, the arrangement of components shown in FIG. 7 cooperates to present a modular light kit assembly that can be installed on a helmet through adhesive attachment and that provides coordinated lighting functionality through the circuitry carried within the housing. The Double-Sided Tape 9 secures the Base 1 to the helmet, the battery 3 provides operating power to the circuitry and to the LED Strips 4, the Flexible Board 5 provides electrical interconnection among the internal components and supports signal routing across the curved interior geometry of the housing, the Button 6 provides user-actuatable control of operational states of the assembly, the Top Cover 7 encloses the internal components within the interior cavity of the Base 1, the Screws 8 mechanically secure the Top Cover 7 to the Base 1, and the LED Strips 4 extend outwardly from the housing along opposite lateral sides to present elongated illumination paths visible from multiple angles surrounding the wearer. In this manner, the light kit assembly shown in FIG. 7 provides a self-contained lighting module that can be affixed to a helmet to present directional turn indications, brake indications, and general visibility illumination in coordination with signals received from a vehicle-side module as described with respect to FIG. 2.

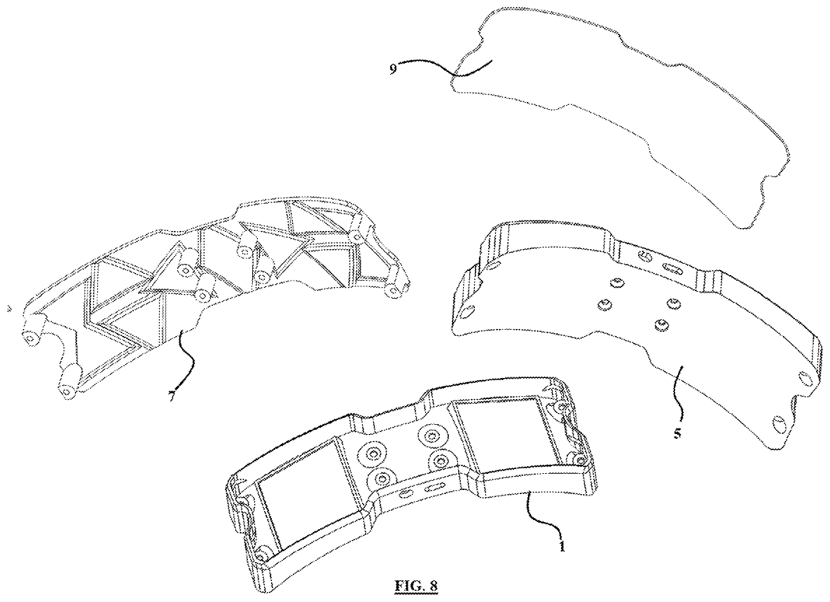

FIG. 8 is an exploded perspective view of a light kit housing assembly of the illumination device assembly described with respect to FIG. 1, illustrating the cooperative arrangement of the housing members, the internal flexible support substrate, and the adhesive attachment layer in a separated relationship that reveals their individual geometries and mutual interfaces. The light kit housing assembly depicted in FIG. 8 serves as the structural shell of the illumination device assembly and is configured to enclose the internal electronics of the assembly while affixing the assembly to an exterior surface, such as an outer shell of a helmet. As shown in FIG. 8, the light kit housing assembly includes a Base 1 that defines a lower housing shell, a Flexible Board 5 that is supported within the housing shell and provides a substrate for internal electrical interconnections, a Top Cover 7 that overlies the lower housing shell to enclose the internal components, and a Double-Sided Tape 9 disposed above the housing to affix the light kit housing assembly to an exterior surface of a helmet. The components shown in FIG. 8 are illustrated in an exploded relationship along an assembly axis to reveal the stacked arrangement of the Flexible Board 5 between the Base 1 and the Top Cover 7, together with the positional relationship of the Double-Sided Tape 9 relative to the assembled housing.

In one aspect, the Base 1 is depicted in FIG. 8 as a contoured lower housing shell having a curved longitudinal profile that follows an exterior curvature of a rear region of a helmet. The Base 1 includes a pair of laterally spaced recessed regions formed along an upper surface thereof, the recessed regions being sized and shaped to receive internal components of the illumination device assembly such as batteries, circuit board elements, and wireless communication modules described with respect to earlier figures. A plurality of fastener-receiving bosses extend upwardly from a central region of the Base 1 between the recessed regions, the fastener-receiving bosses being arranged in a spaced-apart pattern and configured to receive threaded shanks of fasteners that pass downwardly through corresponding openings in the Top Cover 7 to mechanically secure the Top Cover 7 to the Base 1. Furthermore, the Base 1 presents a peripheral sidewall extending upwardly around the recessed regions to define an interior cavity of the housing, and includes one or more lateral openings formed along the peripheral sidewall that are configured to permit passage of proximal ends of LED strips from the interior cavity outwardly to an exterior of the housing. The curved longitudinal profile of the Base 1 further conforms the lower surface of the housing to the contour of the helmet shell, such that the Base 1 can be seated against the helmet shell in a conformal relationship when the light kit housing assembly is mounted thereto.

According to an embodiment, the Flexible Board 5 is depicted in FIG. 8 as a contoured open-framework substrate having a curvilinear outline that corresponds to the longitudinal profile of the Base 1. The Flexible Board 5 includes a network of interconnected web members and frame portions that define a plurality of open regions distributed across the substrate, with the open regions reducing the mass of the Flexible Board 5 and enhancing bendability of the substrate along the curved contour of the housing. The network of interconnected web members can carry conductive traces routed along bendable dielectric portions of the substrate, thereby providing electrical interconnections between a printed circuit board received within the Base 1 and additional components of the illumination device assembly such as the LED strips and the button described with respect to FIG. 1. The Flexible Board 5 includes a plurality of mounting openings distributed at spaced-apart locations along the substrate, the mounting openings being positioned to align with the fastener-receiving bosses of the Base 1 when the Flexible Board 5 is seated within the interior cavity of the Base 1. Additionally, the Flexible Board 5 includes lateral extension regions that extend outwardly toward the lateral openings of the Base 1 and that terminate at connection points configured to place the Flexible Board 5 in electrical communication with proximal ends of the LED strips received through the lateral openings.

In some embodiments, the Top Cover 7 is depicted in FIG. 8 as a contoured cover member having a curved longitudinal profile that corresponds to the curved longitudinal profile of the Base 1 and that is configured to be seated against the peripheral sidewall of the Base 1 to enclose the interior cavity. The Top Cover 7 includes a plurality of fastener openings extending therethrough at locations positioned to align with the fastener-receiving bosses of the Base 1 when the Top Cover 7 is seated in the closed position, such that threaded fasteners can pass through the fastener openings and engage the fastener-receiving bosses to mechanically secure the Top Cover 7 to the Base 1. The Top Cover 7 can further include a plurality of relief windows formed through an upper wall thereof at locations overlying the recessed regions of the Base 1, the relief windows permitting passage of light from internal light-emitting elements to an exterior of the housing and accommodating projecting features of internal components such as actuator portions of the button described with respect to FIG. 1. Furthermore, the Top Cover 7 includes a peripheral lip extending downwardly from the upper wall, the peripheral lip being sized and shaped to seat against an upper edge of the peripheral sidewall of the Base 1 to present a substantially continuous outer envelope around the perimeter of the housing when the Top Cover 7 is in the closed position.

Additionally, the Double-Sided Tape 9 is depicted in FIG. 8 as a thin, contoured adhesive layer having an outline that corresponds to a footprint of an underside of the Base 1 and that is shown in an exploded relationship above the housing to indicate its attachment relationship thereto. Although illustrated above the housing in FIG. 8 for clarity of depiction, the Double-Sided Tape 9 is configured to be disposed along an underside of the Base 1 when the light kit housing assembly is installed on a helmet, with a first adhesive-bearing face of the Double-Sided Tape 9 engaging the underside of the Base 1 and an opposing second adhesive-bearing face of the Double-Sided Tape 9 engaging an outer shell of the helmet. The Double-Sided Tape 9 can include a carrier layer disposed between the first and second adhesive-bearing faces to provide dimensional stability to the adhesive layer and to accommodate the curved contour of the helmet shell against which the Double-Sided Tape 9 is pressed during installation. Furthermore, the Double-Sided Tape 9 can include one or more release liners covering the adhesive-bearing faces prior to installation, with the release liners being removable at the time of installation to expose the adhesive and enable attachment of the light kit housing assembly to the helmet without penetration of, or mechanical fastening into, the helmet shell, such that the structural integrity of the helmet is preserved during installation and use of the illumination device assembly.

Furthermore, the components depicted in FIG. 8 cooperate to present a self-contained housing architecture for the illumination device assembly described with respect to FIG. 1 that can be installed on a helmet through adhesive attachment. The Base 1 provides a contoured lower shell that supports and protects the internal electronics within the recessed regions of the housing, the Flexible Board 5 provides an open-framework substrate that carries electrical interconnections across the curved interior geometry of the Base 1 while reducing mass and accommodating bending along the curved longitudinal profile, the Top Cover 7 overlies and encloses the internal components within the interior cavity and presents a contoured outer envelope that conforms to the curvature of the Base 1, and the Double-Sided Tape 9 affixes the assembled housing to the outer shell of the helmet through adhesive engagement without compromising the structural integrity of the helmet. In this manner, the light kit housing assembly shown in FIG. 8 provides a modular housing architecture that can be assembled from discrete components, populated with internal electronics during manufacture, and adhesively mounted to a helmet during installation, thereby enabling the illumination device assembly to present coordinated signaling and illumination functionality as described with respect to FIG. 1 and FIG. 2 while preserving the protective performance of the helmet to which the assembly is mounted.

Although the foregoing description frequently refers to a motorcycle helmet and a motorcycle-mounted module, the disclosed structures and methods can be adapted for use with other protective headgear and other vehicles. By way of example, the illumination device assembly can be mounted to bicycle helmets, scooter helmets, off-road helmets, construction helmets, industrial hard hats, or other headgear, and the vehicle-side module can be adapted for use with motorcycles, scooters, mopeds, all-terrain vehicles, utility task vehicles, bicycles equipped with electrical signaling systems, open-cab work vehicles, or other mobile platforms. In implementations where a vehicle-side electrical interface is unavailable or undesired, one or more inertial sensors carried by the illumination device assembly can be used as an alternative control source for selected lighting behaviors.

In some embodiments, the illumination device assembly can be manufactured as an aftermarket kit configured for adhesive attachment to an existing helmet. In additional embodiments, the illumination device assembly can be incorporated into a helmet during original manufacture, such that one or more housing portions, light-emitting elements, wiring structures, or control components are integrated into the helmet while preserving impact-performance requirements of the helmet. In either configuration, the lighting system can be arranged to maintain a low-profile external envelope and to provide signaling visible from multiple angles surrounding the wearer.

1. An illumination device assembly comprising:
a base;
a printed circuit board supported relative to the base;
a battery in electrical communication with the printed circuit board;
at least one LED strip in electrical communication with the printed circuit board and extending outwardly from the base;
a flexible board supported relative to the base and providing electrical interconnection between the printed circuit board and the at least one LED strip;
a button operable by a user and configured to control an operational state of the illumination device assembly;
a top cover connectable to the base to enclose the printed circuit board, the battery, and the flexible board;
at least one screw configured to secure the top cover to the base; and
a double-sided tape configured to adhere the illumination device assembly to an exterior surface.

2. The illumination device assembly of claim 1, wherein the exterior surface comprises an outer shell of a helmet.

3. The illumination device assembly of claim 1, wherein the double-sided tape is configured to adhere the base to an outer shell of a helmet without penetration of the outer shell.

4. The illumination device assembly of claim 1, wherein the base defines an interior cavity sized to receive the printed circuit board, the battery, and the flexible board.

5. The illumination device assembly of claim 4, wherein the base includes a plurality of fastener-receiving features arranged along a peripheral rim thereof to receive the at least one screw.

6. The illumination device assembly of claim 1, wherein the battery comprises a rechargeable lithium-based battery.

7. The illumination device assembly of claim 6, wherein the rechargeable lithium-based battery comprises a lithium-ion cell or a lithium-polymer cell.

8. The illumination device assembly of claim 1, wherein the battery comprises a plurality of batteries positioned at opposite sides of the printed circuit board.

9. The illumination device assembly of claim 1, wherein the at least one LED strip comprises a plurality of LED strips, a first portion of the plurality of LED strips extending outwardly from a first lateral side of the base and a second portion of the plurality of LED strips extending outwardly from an opposite second lateral side of the base.

10. The illumination device assembly of claim 9, wherein the plurality of LED strips define a left-side indication portion and a right-side indication portion that are independently controllable by the printed circuit board.

11. The illumination device assembly of claim 1, wherein the at least one LED strip includes a brake indication portion and a turn indication portion, the brake indication portion being arranged along a rearward region of the base and the turn indication portion being arranged to extend along at least one lateral side of the base.

12. The illumination device assembly of claim 11, wherein the printed circuit board is configured to independently control the brake indication portion and the turn indication portion.

13. The illumination device assembly of claim 11, wherein the brake indication portion is configured to emit light according to a different pattern than the turn indication portion.

14. The illumination device assembly of claim 1, wherein the button is configured such that actuation of the button for a predetermined duration toggles the illumination device assembly between an activated state and a deactivated state.

15. The illumination device assembly of claim 14, wherein a second actuation pattern of the button initiates a pairing mode of the illumination device assembly.

16. The illumination device assembly of claim 1, wherein the printed circuit board is configured to cause the at least one LED strip to provide a visible indication of at least one of pairing status, connection status, charging status, and battery status.

17. The illumination device assembly of claim 1, wherein the battery is configured to be recharged through a charging interface carried by the printed circuit board.

18. The illumination device assembly of claim 17, wherein the charging interface comprises a plug-receiving receptacle.

19. The illumination device assembly of claim 17, wherein the charging interface comprises a wireless charging interface.

20. The illumination device assembly of claim 17, wherein the printed circuit board is configured to drive the at least one LED strip to flash during charging of the battery.
